(19) United States
(12) Patent Application Publication
(10) Pub. No.: US 2026/0313010 A1
(43) Pub. Date: Oct. 8, 2026

(54) SIGNALLING A CONFIGURATION REQUEST

(71) Applicant: LENOVO (SINGAPORE) PTE. LTD., Singapore (SG)

(72) Inventors: Razvan-Andrei STOICA, Essen (DE); Dimitrios KARAMPATSIS, Ruislip (GB); Roozbeh ATARIUS, La Jolla, CA (US)

(21) Appl. No.: 19/480,678

(22) PCT Filed: Nov. 7, 2023
(86) PCT No.: PCT/EP2023/080930

§ 371 Date: Oct. 31, 2025

(30) Foreign Application Priority Data
Oct. 25, 2023 (GR) 20230100893

(51) Int. Cl. H04L 65/65; H04L 65/1069; H04L 65/80

(52) U.S. Cl. CPC H04L 65/65; H04L 65/1069; H04L 65/80

(57) ABSTRACT

Various aspects of the present disclosure relate to include a user equipment, UE, comprising at least one memory and at least one processor coupled with the at least one memory. The processor is configured to cause the user equipment to transmit a user plane QoS session configuration request, the request comprising first and second information. The first information indicates at least one of a type of media, a set of QoS parameters requirements, or a protocol description, for one or more media components of multimedia application data, and the second information indicates a PDU Set marking configuration identifying a PDU Set marking for the one or more media components. The PDU Set marking configuration comprises information elements corresponding to or indicative of a Real Time Protocol, RTP, header extension configuration used for marking PDU Set information.

### TECHNICAL FIELD

The present disclosure relates to wireless communications and more specifically to methods and apparatus for signalling a configuration request.

### BACKGROUND

A wireless communications system may include one or multiple network communication devices such as base stations, which may support wireless communications for one or multiple user communication devices, which devices may be otherwise known as user equipment (UE) or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

“Virtual Reality” (VR) is a rendered version of a delivered visual and audio scene. The rendering is intended to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones to provide the user with accompanying audio. Some form of head and motion tracking of the user in VR may be used to allow the simulated visual and audio components to be updated to ensure that, from the user's perspective, items and sound sources remain consistent with the user's movements. In some implementations additional means to interact with the virtual reality simulation may be provided but are not strictly necessary.

“Augmented reality” (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

“XR” is referred to hereafter as an umbrella term for different types of digital realities according to 3GPP Technical Report TR 23.700-60 (v0.0.3-May 2022). XR refers to all real-and-virtual combined environments and human-machine interactions generated by computer technology and wearables. It includes representative forms such as AR, MR and VR and the areas interpolated among them. The levels of “virtuality” range from partial sensory inputs to fully immersive VR. A key aspect of XR is the extension of human experiences especially relating to the senses of existence (represented by VR) and the acquisition of cognition (represented by AR).

The XR Media (XRM) feature in 3GPP Release 18 at the core network (CN) level, introduced the concept of a Protocol Data Unit (PDU) “Set” to handle QoS requirements of XRM applications and streams with a better granularity beyond 5G Rel-17 QoS flow possibilities. As such, according to TR 23.700-60 cited above and 3GPP Technical Specification TS 23.501(v18.2.2-June 2023), “a PDU set is composed of one or more PDUs carrying the payload of one unit of information generated at the application level (e.g. a frame or video slice for XRM Services). In some implementations, all PDUs in a PDU Set are needed by the application layer to use the corresponding unit of information. In other implementations, the application layer can still recover parts or all of the information unit when some PDUs are missing”.

In addition, the PDU set is associated with Quality of Service (QOS) requirements in terms of delay budget and error rate as, cf above cited TS 23.501:
A PDU Set Delay Budget (PSDB) which defines an upper bound for the time that a PDU-Set may be delayed between the UE and the N6 termination point at the User Plane Function (UPF). A PSDB applies to the Downlink (DL) PDU-Set received by the UPF over the N6 interface, and to the Uplink (UL) PDU-Set sent by the UE;
A PDU Set Error Rate (PSER) which defines an upper bound for the rate of PDU-Sets (e.g. set of IP packets constituting a PDU-Set) that have been processed by the sender of a link layer protocol (e.g. Radio Link Control (RLC) in RAN of a 3GPP access), but where all of the PDUs in the PDU-Set are not successfully delivered by the corresponding receiver to the upper layer (e.g. Packet Data Convergence Protocol (PDCP) in RAN of a 3GPP access), whereas the PSER is used to determine an upper bound for a rate of non-congestion-related packet losses.

An overview of the CN XRM architecture handling of PDU sets is depicted in FIG. 1. The general processing steps for DL traffic are:
1. The Application Function (AF) provides QoS requirements for packets of a PDU set to the Policy Control Function (PCF), i.e. PSDB and PSER, and information to identify the application (i.e. 5-tuple or application id). The AF may also include an importance parameter for a PDU set and information for the core network to identify packets belonging to a PDU set.
2. The PCF derives QoS rules for the XR application (i.e. use a 5QI for XR media traffic) and specific QoS requirements for the PDU set and configures the Session Management Function (SMF). The PCF may include PCC rules per importance of a PDU set (according to information received from the AF or based on operator configuration).
3. The SMF establishes a QoS flow according to the QoS rules by the PCF and configures the User Plane Function (UPF) to route packets of the XR application to a QoS flow and, in addition, to enable PDU set handling. The SMF also provides the QoS profile containing PDU set QoS requirements to the RAN via the Access and Mobility Management Function (AMF).
4. The UPF inspects the packets and determines packets belonging to a PDU set (e.g., based on the UPF implementation given, for instance by inspecting the Real-time Transport Protocol (RTP) packet headers (see above referenced TS 23.501) or based on AS-marked PDU set information transmitted over RTP PDU Set header extensions (again see referenced TS 23.501 and 3GPP Technical Specification TS 26.522 (v0.1.1-September 2023), i.e., urn:3gpp:pdu-set-marking:rel-18)). When the UPF detects packets of a PDU set, the UPF marks the packets belonging to a PDU set within a GPRS Tunnelling Protocol User Plane (GTP-U) header. The GTP-U header information includes a PDU set sequence number and the size of the PDU set. The UPF may also determine the importance of the PDU set either based on UPF implementation means, information provided by the AF or information provided as metadata from the AS. Based on the importance of the PDU set, the UPF may route the traffic to a corresponding QoS flow (according to the rules received from the SMF) or include the importance of the PDU set within a GTP-U header.
5. The RAN identifies packets belonging to a PDU set (based on the GTP-U marking) and handles the packets of the PDU set according to the QoS requirements of the PDU set provided by the SMF. In one implementation, the RAN node may use a different radio bearer with higher QoS requirement (according to the PDU set PSDB/PSER) to guarantee delivery of the packets of the PDU set, while using a different radio bearer according to the 5QI of the QoS flow for the non-PDU set packets.

It is noted that, in XRM Release 18, once the PDU set QoS integrated handling is enabled, the PDU Session Anchor (PSA) UPF identifies PDUs that belong to PDU sets and determines for each PDU set the PDU set information below, sent over to the NG-RAN in the GTP-U header:
PDU Set Sequence Number.
Indication of End PDU of the PDU Set.
PDU Sequence Number within a PDU Set.
PDU Set Size in bytes.
PDU Set Importance, which identifies the relative importance of a PDU Set compared to other PDU Sets within a QoS Flow.

The PDU Set information is then used by the NG-RAN for PDU Set based QoS handling as described above.

The NG-RAN may use Priority Levels (cited TS 23.501, clause 5.7.3.3) across QOS Flows and PDU Set Importance within a QoS Flow for PDU Set level packet discarding in presence of congestion.

It is also specified in cited TS 23.501 that the PSA UPF identifies PDUs that belong to PDU Sets and, if the UPF receives a PDU that does not belong to a PDU Set based on Protocol Description for PDU Set identification (e.g., has not been marked with PDU Set information by the AS), then the UPF still maps the PDU to a PDU Set and determines the PDU Set Information as described above. This ensures that, for a QoS flow with PDU Set enabled, all of the PDUs belong to a PDU Set. To this end, if the PSA UPF receives a PDU that does not belong to a PDU Set, it is assumed that the UPF determines the PDU Set Importance value based in some embodiments on pre-configuration and in other embodiments on an AS/AF signalled default importance.

The AS PDU Set information listed above is provided in some embodiments via a one-byte RTP Header Extension for the marking of PDU Sets, and End of Bursts as defined by TS 26.522 illustrated in FIG. 2A. In other embodiments, the AS may use the two-byte RTP Header Extension for the marking of PDU Sets, and End of Bursts as defined by TS 26.522 illustrated in 2B.

The semantics of the fields denoted in FIGS. 2A and 2B of the RTP Header Extension for the marking of PDU Set and End of Bursts are:
End PDU of the PDU Set [E] (1 bit field): a flag set to 1 for the last PDU of the PDU Set and set to 0 for all other PDUs of the PDU Set.
End of Data Burst [EDB] (up to 3 bits field): indicates the end of a Data Burst being set to a non-zero value when the end of data burst is present and 0 otherwise.
PDU Set Importance [PSI] (4 bits field): indicates the importance of a PDU Set compared to other PDU Sets within the same QoS flow. Lower values indicate a higher importance PDU Set with the highest importance PDU Set of 0 and the lowest importance PDU Set of 15.
PDU Set Sequence Number [PSSN] (10 bits field): encodes the sequence number of the PDU Set to which the current PDU belongs acting as a 10-bit numerical identifier for the PDU Set and wraps around at 1023.
PDU Sequence Number within a PDU Set [PSN] (6 bits field): indicates the sequence number of the current PDU within the PDU Set. The PSN is set to 0 for the first PDU in the PDU Set and incremented monotonically for every PDU in the PDU set in order of transmission from the sender. PSN wraps around 63.
PDU Set Size [PSSize] (24 bits field): indicates the total size of all PDUs of the PDU Set to which this PDU belongs. This field is optional and subject to an SDP signaling offer/answer negotiation, where the AS may indicate whether it will be able to provide the size of the PDU Set for that RTP stream. If not enabled, the field is not present. If enabled, but the AS is not able to determine the PDU Set Size for a particular PDU Set, it should set the value to 0 in all PDUs of that PDU Set. The PSSize indicates the size of a PDU Set including RTP/UDP/IP header encapsulation overhead of its corresponding PDUs. The PSSize is expressed in bytes.

Reciprocal processing is applicable to UL, where the role of UPF packet inspection is taken by the UE which is expected to inspect packets, determine packets belonging to a PDU set, and signal accordingly the PDU set to the RAN for scheduling and resource allocation corresponding to an associated Data Radio Bearer (DRB) capable of fulfilling the PDU set QoS requirements (i.e., PSDB and PSER). The low-level signaling mechanism associated with the UL UE-to-RAN information exchange is dependent on the specification and implementations of RAN signaling procedures.

Depending on the QoS flow mappings and RAN procedures, several alternative PDU set to QoS flow to DRB mappings are possible given two distinct PDU sets with different PDU set attributes, such as PDU set importance. FIG. 3 relates to two PDU sets of different importance and characteristics being mapped to QoS flows and respectively to DRBs. Consider in this example PDU set 1 to be of high importance with strict QoS requirements (i.e., PSDB, PSER etc.) and PDU set 2 to be of low importance with potentially lower QoS requirements (i.e., PSDB, PSER etc.) than PDU set 1. As illustrated in FIG. 3, the PDU set to QoS flow to DRB can take the following instantiations depending on QoS flow policies and Layer 2 RAN procedures:
a) 1-to-1-to-1: The separation of QoS flows and DRBs is strict between high and low importance PDU sets, thereby optimizing finely the radio and network resources on a per PDU set basis.
b) M-to-M-to-1: The separation between high and low importance PDU sets is performed only at the QoS flow level, whereas the same DRB is used for the over-the-air transmission of both PDU sets. This may lead to overprovisioning of radio resources for low importance PDU sets but requirer a lower overhead of RAN complexity and management.
c) M-to-1-to-1: There is no separation between the QoS flows and DRBs of different importance PDU sets, and the higher importance PDU set QoS requirements define the priority for handling the QoS across both CN and RAN. This may lead to overprovisioning of resources for low importance PDU sets in both CN and RAN implementations but requires lower overhead and control within the 5GS QoS framework.
d) M-to-1-to-M: There is no separation across the QoS flows between PDU set importance levels, yet distinct DRBs are used to cater for the individual requirements of the distinct importance levels. This compromises the QoS flow management complexity and uses PDU set information to filter the PDU sets on different DRBs in order to better match the QoS requirements at RAN level and optimize resource allocation according to individual PDU set needs.

The transport of multimedia flows is primarily addressed by the WebRTC protocol stack or, alternatively, its underlying transport encapsulation to RTP/SRTP for media and SCTP for data channels.

In Release 17, SA4 analyzed for instance the XR traffic model, cf. 3GPP Technical Report TR 26.928(v17.0.0—April 2022), and concluded the QoS requirements in terms of delay budget, data rate and error rate necessary for a satisfactory experience at the application level. This led to four additional 5QIs for the 5GS XR QOS flows (as part of above cited TS 23.501) as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080 p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.). Furthermore, XR traffic also includes one or more audio streams, as well as user interaction metadata (e.g., user actions, user inputs, user pose), or alternatively, feedback and control metadata (actions, XR space metadata, as well as transport control and feedback messages over RTCP for instance).

The traffic of immersive and interactive XR applications such as the ones described above often require real-time suited transport architectures and protocols. As part of the latter, the state of art is represented by the Real-time Transport Protocol (RTP), RFC 3550—RTP: A Transport Protocol for Real-Time Applications (ietf.org), its securely provisioned Secure Real-time Transport Protocol (SRTP), RFC 3711—The Secure Real-time Transport Protocol (SRTP) (ietf.org), and its web-targeted stack Web Real-Time Communications WebRTC, WebRTC 1.0: Real-Time Communication Between Browsers (w3.org), respectively.

RTP is a media-codec-agnostic network protocol with application-layer framing used to deliver multimedia (e.g., audio, video etc.) data in real-time over IP networks. It is used in conjunction with a sister protocol for control, i.e., Real-time Transport Control Protocol (RTCP), to provide end-to-end features such as jitter compensation, packet loss and out-of-order delivery detection, synchronization, and source streams multiplexing. An overview of the RTP and RTCP stack illustrated in FIG. 4.

SRTP is a secured version of RTP, providing encryption (mainly by means of payload confidentiality), message authentication and integrity protection (by means of PDU, i.e., headers and payload, signing), as well as replay attack protection. Similarly to RTP, the SRTP sister protocol is SRTCP. This provides the same functions to its RTCP counterpart.

The RTP and SRTP header information share the same format as provided below in FIG. 5.

In generic SRTP versions, the RTP header information is still accessible but non-modifiable, whereas the payload is encrypted. These security provisions are illustrated in part over the right-hand side of FIG. 5. Furthermore, the key exchange and additional security parameters necessary to use SRTP are based upon the Datagram Transport Layer Security (DTLS) key exchange procedure. SRTP is used for these reasons as the transport protocol for media in the WebRTC stack which ensures secure RTC multimedia communications over web browser interfaces.

An overview of the WebRTC stack is provided in FIG. 6. As illustrated, an IP layer carries signaling from the data plane and the control plane. The data plane stack comprises functions for User Datagram Protocol (UDP), Interactive Connectivity Establishment (ICE), Datagram Transport Layer Security (DTLS), SRTP, SRTCP, media codecs, Quality Control and SCTP. ICE may use the Session Traversal Utilities for NAT (STUN) protocol and Traversal Using Relays around NAT (TURN) to address real-time media content delivery across heterogeneous networks and NAT rules and firewalls. The SCTP data plane is mainly dedicated as an application data channel and may be non-time critical, whereas the SRTP based stack including elements of control, i.e., SRTCP, encoding, i.e., media codecs, and Quality of Service (QOS), i.e., Quality Control, is dedicated to time-critical transport.

The data plane is usually established over a single application session (i.e., a 5-tuple) multiplexing the transport of media (i.e., video, audio, haptic media codec payloads), of user plane quality control and feedback based on RTCP messages and of WebRTC data channels (i.e., application data such as user chat messages, notifications, user inputs, user actions, user pose etc.) over SCTP/DTLS.

The RTP/SRTP fixed header information and complete header information (including header extensions) is as follows, in accordance with cited RFC 3550 and RFC 3711:

### Fixed Header Information

V—2 bits indicating the protocol version used.
P—1 bit field indicating that one or more zero-padded octets at the end of the payload are present, whereby, among others, the padding may be necessary for fixed-sized encrypted blocks or for carrying multiple RTP/SRTP packets over lower layer protocols.
X—1 bit indicating that the standard fixed RTP/SRTP header will be followed by an RTP header extension usually associated with a particular data/profile that will carry more information about the data (e.g., as per RFC 8285: A General Mechanism for RTP Header Extensions (rfc-editor.org)).
CC—4 bits indicating number of contributing media sources (CSRC) that follow the fixed header.
M—1 bit intended to mark an information frame boundary in the packet stream, whose behavior is exactly specified by RTP profiles (e.g., H.264, H.265, H.266, AV1 etc.).
PT—7 bits indicating the payload type, which in case of video profiles is dynamic and negotiated by means of SDP (e.g., 96 for H.264, 97 for H.265, 98 for AV1 etc.).
Sequence number—16 bits indicating the sequence number which increments by one with each RTP data packet sent over a session.
Timestamp—32 bits indicating timestamp in ticks of the payload type clock reflecting the sampling instant of the first octet of the RTP data packet (associated for video stream with a video frame), whereas the first timestamp of the first RTP packet is selected at random.
Synchronization Source (SSRC) identifier—32 bits field indicating a random identifier for the source of a stream of RTP packets forming a part of the same timing and sequence number space, such that a receiver may group packets based on synchronization source for playback.
Contributing Source (CSRC) identifier—list of up to 16 CSRC items of 32 bits each given the amount of CSRC mixed by RTP mixers within the current payload as signaled by the CC bits; the list identifies the contributing sources for the payload contained in this packet given the SSRC identifiers of the contributing sources.

### Complete Header Information (Incl. Header Extensions)

RTP header extension—a variable length field present if the X bit is marked; the header extension is appended to the RTP fixed header information after the CSRC list if present; the RTP header extension is 32-bit aligned and formed of the following fields:
A 16-bit extension identifier defined by a profile and usually negotiated and determined via the Session Description Protocol (SDP) signaling mechanism.
A 16-bit length field describing the extension header length in 32-bits multiples excluding the first 32 bits corresponding to the 16 bits extension identifier and the 16 bits length fields itself
A 32-bit aligned header extension raw data field formatted according to some RTP header extension identifier specified format.

The RTP header extension format and syntax are similar to those of SRTP. These are commonly illustrated in FIG. 7. In addition, in both RTP and SRTP, only one RTP extension header may be appended to the fixed header information. However, for both RTP and SRTP, extensions to the base protocols exist to allow for multiple RTP header extensions of predetermined types to be appended to the fixed header information of the protocols, as per RFC 8285: A General Mechanism for RTP Header Extensions (rfc-editor.org).

In some embodiments, RTP header extensions produced at the source may be ignored by the destination endpoints that do not have the knowledge to interpret and process the RTP header extensions transmitted by the source endpoint.

5GS specifies limited support for multimodal flows in terms of providing a common multimodal service ID for the PCF to correlate QoS policy and rules for multiple flows over a common PDU Session as per [TS 23.501, Clause 5.37.2]. No architectural features in the CN (e.g., at the UPF) or in the RAN are thus available for dedicated support of multimodal flows and differentiated traffic support.

Furthermore, from the perspective of 5G multimedia, interactive and immersive architecture, the interface between the AS and the AF, i.e., M3 in the context of 5G Media Streaming TS 26.501, and respectively, RTC-3 in the context of 5G Real-time Communications TS 26.506, is up to the implementation and currently “out scoped” by the 5GS. This is set to change given the extension of AS-driven provisioning of 5GS service support regarding dynamic policies, service adaptation, as well as requests for optimized QoS handling of multimedia related applications.

Multimodal flow specification support is offered over N5 interface at the PCF via the Npcf_Policy Authorization service (cf. 3GPP Technical Specification TS 29.514 (v18.3.0-Sep. 2023)), or alternatively, over N33 interface at the NEF via the Nnef_AFSession WithQOS service (cf. 3GPP Technical Specification TS 29.112 (v 18.3.0—September 2023)) to provide a multimodal service ID, a protocol description of one or more media components and a list of QOS requirements for one or more multiple IP data flows associated with the same multimodal service ID.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include a user equipment, UE, comprising at least one memory and at least one processor coupled with the at least one memory. The processor is configured to cause the user equipment to transmit a user plane QoS session configuration request, the request comprising first and second information. The first information indicates at least one of a type of media, a set of QoS parameters requirements, or a protocol description, for one or more media components of multimedia application data, and the second information indicates a PDU Set marking configuration identifying a PDU Set marking for the one or more media components. The PDU Set marking configuration comprises information elements corresponding to or indicative of a Real Time Protocol, RTP, header extension configuration used for marking PDU Set information.

In some implementations of the method and apparatuses described herein the processor may be configured to cause the UE to operate as an RTP sender, and wherein the configuration request is sent within a service API request to a service API belonging to a network function.

In some implementations the second information may be an information element within the first information.

In some implementations, the RTP header extension configuration may be based on a Software Defined Protocol, SDP, procedure, and wherein the information elements are encoded based on the SDP procedure.

In some implementations, the first information may indicate the protocol description of at least one media component and wherein the first information further comprises an information element indicating an Internet Protocol (IP) version associated with the multimedia application data, and wherein the IP version associated with the multimedia data is based at least in part on the SDP procedure.

In some implementations, the configuration request may be common to one or more media components, optionally as part of a AsSessionWithQoSSubscription or AsSessionWithQoSSubscriptionPatch Service API request, or specific to each one of the one or more media components optionally as part of a AsSessionMediaComponent or MediaComponent service API request.

In some implementations, the network function may be one of:
an Application Function, AF, optionally a Media Application Function or an XR Media Application Function;
a WebRTC Signalling Server; and
a Proxy Call Session Control Function, P-CSCF.

In some implementations, the information elements of the PDU Set marking configuration may comprise at least one of
a version field identifying the syntax and semantics of the used RTP header extension for marking PDU Set information;
a format field identifying an RTP header extension format negotiated within the SDP offer/answer procedure;
an identifier field corresponding to the RTP header extension used to send the PDU set information as part of one or more RTP header extensions negotiated within the SDP offer/answer procedure;
a PDU set size indicator field corresponding to an indication of activation of PDU Set Size information as part of the PDU Set information;
an origin IP version field corresponding to the IP version used at the RTP sender to transmit the multimedia application data, optionally the origin IP version may be any binary indication of one of an IPv4 or IPv6; and
an end of data burst indicator field corresponding to an indication of activation of end of data bursts information as part of the PDU Set information.

In some implementations, the configuration request may be included within a data model corresponding to a DynamicPolicy, ServiceDataFlowDescription, MediaComponent, or a MediaSubComponent included within a service API request sent over an M5/RTC-5 interface to an AF, optionally via the user equipment Media Session Handler interacting with a Maf_SessionHandling service API.

In some implementations, the media type may be one of video, audio, haptics, text, application and control, and the protocol description identifies a protocol type and an RTP payload type corresponding to the media encoding format contained in the RTP payload.

In some implementations, the set of QoS parameters requirements may indicate at least a PDU Set Delay Budget and a PDU Set Error Rate.

Some implementations of the method and apparatuses described herein may further include a processor for wireless communication, comprising at least one controller coupled with at least one memory and configured to cause the processor to send a user plane QoS session configuration request, the request comprising first and second information. The first information indicates at least one type of media, a set of QoS parameters requirements, or a protocol description for one or more media components of multimedia application data, and the second information indicating a PDU Set marking configuration identifying a PDU Set marking for the one or more media components, wherein the PDU Set marking configuration comprises information elements corresponding to or indicative of a Real Time Protocol, RTP, header extension configuration used for marking PDU Set information.

Some implementations of the method and apparatuses described herein may further include a network entity comprising at least one memory and at least one processor coupled with the at least one memory. The processor is configured to cause the network entity to send a user plane QoS session configuration request, the request comprising first and second information. The first information indicates at least one of a type of media, a set of QoS parameters requirements, or a protocol description for one or more media components of multimedia application data, and the second information indicates a PDU Set marking configuration identifying a PDU Set marking for the one or more media components, wherein the PDU Set marking configuration comprises information elements corresponding to or indicative of a Real Time Protocol, RTP, header extension configuration used for marking the PDU Set information.

In some implementations, the processor may be configured to cause the network entity to operate as a first network function and to cause the configuration request to be sent within a service API request to a service API belonging to a second network function.

In some implementations, the first network function may be one of:
an Application Function, AF;
a WebRTC Signalling Server; and
a Proxy Call Session Control Function, P-CSCF.

In some implementations, the second network function may be one of:
a Policy Control Function, PCF; and
a Network Exposure Function, NEF.

In some implementations, the PDU set marking is performed by an RTP sender, the RTP sender and an RTP receiver using the RTP header extension configuration each being located at one of:
a UE including a Media Session Handler; and
an Application Server.

In some implementations, the second information may be an information element within the first information.

In some implementations, the RTP header extension configuration may be based on a Software Description Protocol, SDP, procedure, and wherein the information elements are encoded based on the SDP procedure.

In some implementations, the configuration request may be comprised within a data model corresponding to:
An AsSessionMediaComponent included within one of
   an AsSession WithQosSubscription, and
   an AsSession WithQosSubscriptionPatch request over N33 interface to the NEF,
   optionally via Nnef_AFSession WithQOS service; and
a MediaComponent included within one of
   an AppSessionContextReqData,
   an AppSessionContextUpdateData, and
   an AppSessionContextUpdateDataPatch request over N5 interface to the PCF,
   optionally via Npcf_Policy Authorization service.

Some implementations of the method and apparatuses described herein may further include a method of operating a user equipment (UE) and comprising transmitting a user plane QOS session configuration request, the request comprising first and second information, wherein the first information indicates at least one of a type of media, a set of QoS parameters requirements, or a protocol description, for one or more media components of multimedia application data, and the second information indicates a PDU Set marking configuration identifying a PDU Set marking for the one or more media components, wherein the PDU Set marking configuration comprises information elements corresponding to or indicative of a Real Time Protocol, RTP, header extension configuration used for marking PDU Set information.

Some implementations of the method and apparatuses described herein may further include a method of operating a network entity and comprising sending a user plane QOS session configuration request, the request comprising first and second information, wherein the first information indicates at least one of a type of media, a set of QoS parameters requirements, or a protocol description for one or more media components of multimedia application data, and the second information indicates a PDU Set marking configuration identifying a PDU Set marking for the one or more media components, wherein the PDU Set marking configuration comprises information elements corresponding to or indicative of a Real Time Protocol, RTP, header extension configuration used for marking the PDU Set information.

### BRIEF DESCRIPTION OF THE DRAWINGS

FIG. 1 provides overview of the CN XRM architecture handling of PDU sets.

FIG. 2A illustrates AS PDU Set information provided via a one-byte RTP Header Extension for the marking of PDU Sets and End of Bursts.

FIG. 2B illustrates the use of a two-byte RTP Header Extension for the marking of PDU Sets and End of Bursts.

FIG. 3 illustrates mappings of two PDU sets of different importance and characteristics to QoS flows and respectively to DRBs.

FIG. 4 presents an overview of the RTP and RTCP stack.

FIG. 5 presents RTP and SRTP header information sharing the same format.

FIG. 6 presents an overview of the WebRTC stack.

FIG. 7 illustrates an RTP header extension format and syntax.

FIG. 8 illustrates an example of a wireless communications system in accordance with aspects of the present disclosure.

FIG. 9 illustrates an AppSessionContextReqData object including an optional map of MediaComponents.

FIG. 10 illustrates an AsSessionWithQoSSubscription object including an optional map of type AsSessionMediaComponent.

FIG. 11 illustrates an RTP HE ABNF syntax within the SDP.

FIG. 12 illustrates a Header extension info part of ProtoDesc data model, in an example applicable to AsSessionWithQoSSubscription.

FIG. 13 illustrates a Header extension information in parallel to ProtoDesc data model, in an example applicable to AsSessionWithQoSSubscription.

FIG. 14 illustrates a Header extension info part of ProtoDesc data model, in an example applicable to AppSessionContextReqData.

FIG. 15 illustrates a Header extension information in parallel to ProtoDesc data model, in an example applicable to AppSessionContextReqData.

FIG. 16 illustrates an origin IP version provided as an additional field within the ProtoDesc data model.

FIG. 17 illustrates an origin IP version provided within a PduSetMarking data model as an additional information element.

FIG. 18 illustrates an example of a user equipment (UE) 200 in accordance with aspects of the present disclosure.

FIG. 19 illustrates an example of a processor 300 in accordance with aspects of the present disclosure.

FIG. 20 illustrates an example of a network equipment (NE) 400 in accordance with aspects of the present disclosure.

FIG. 21 illustrate a flowchart of a method performed by a UE in accordance with aspects of the present disclosure.

FIG. 22 illustrate a flowchart of a method performed by a NE in accordance with aspects of the present disclosure.

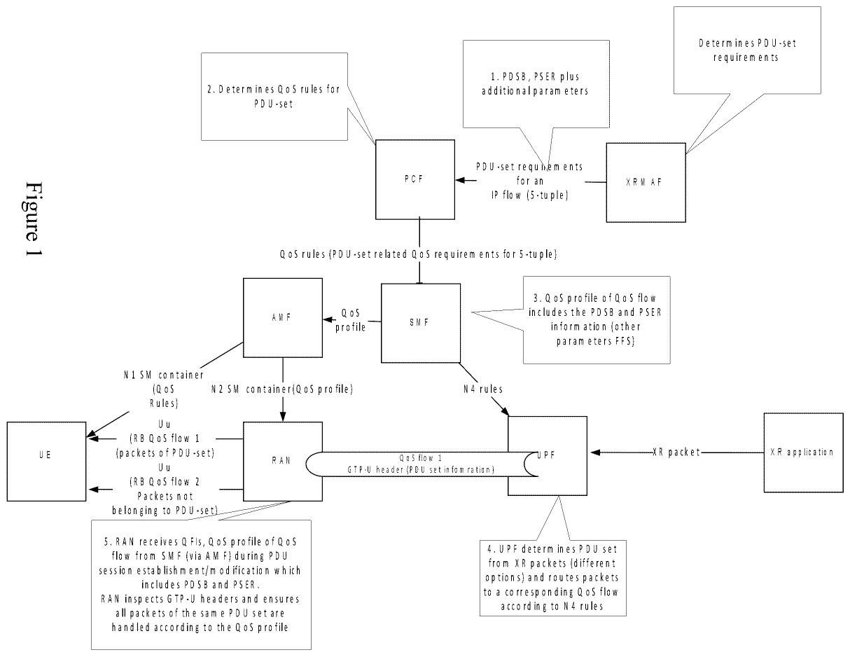

### DETAILED DESCRIPTION

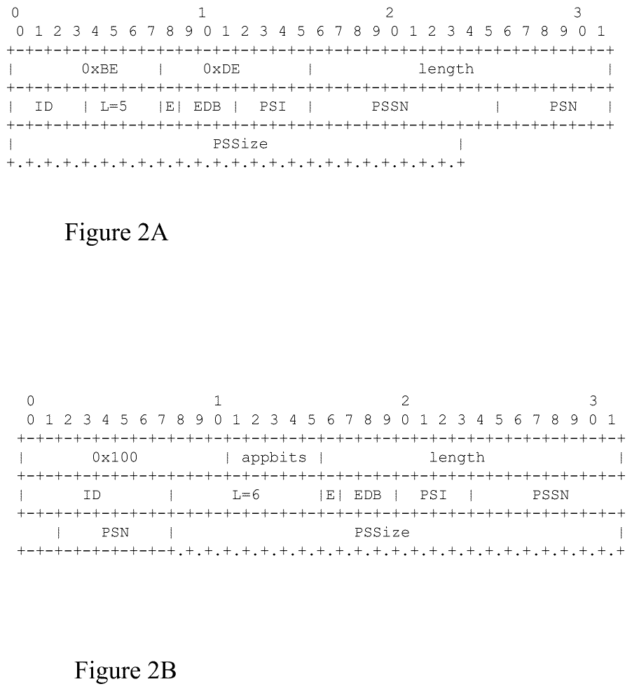

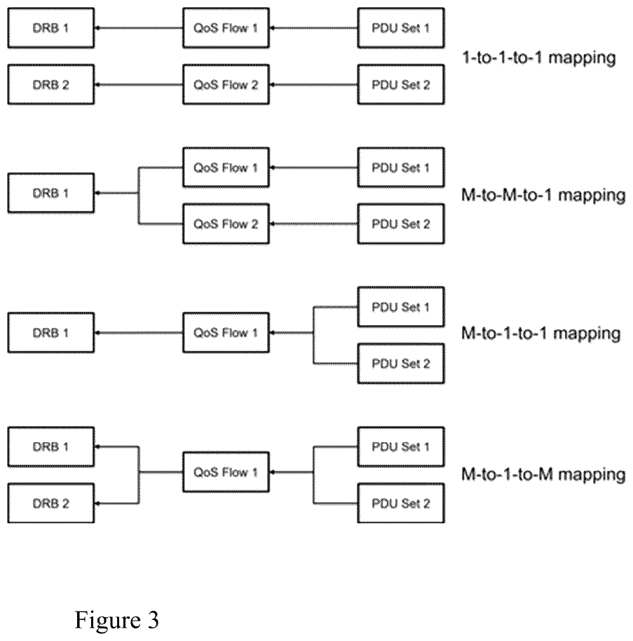

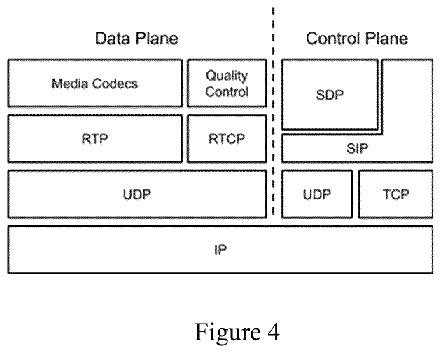

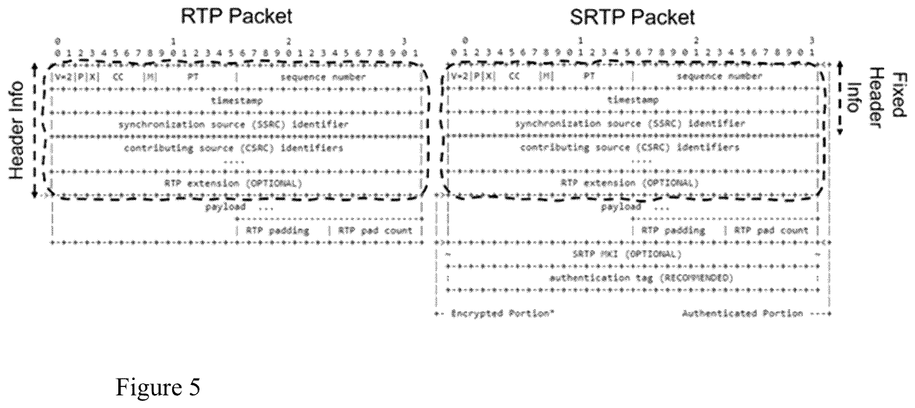

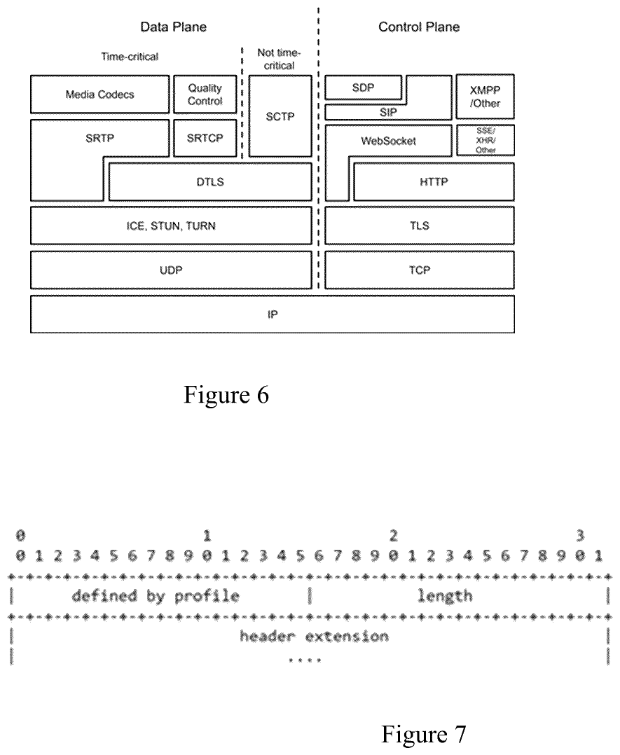

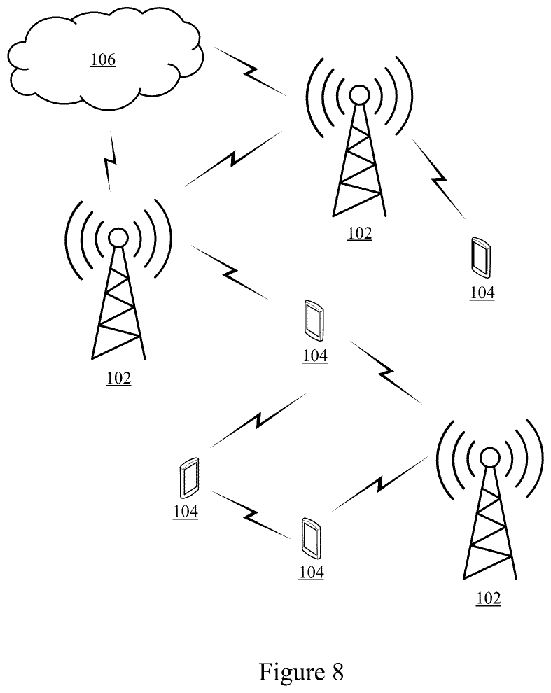

In XR applications (e.g., immersive media communications/conferencing, AR/VR services or even cloud gaming) where an RTP sender (e.g., an AS, or alternatively, a UE) marks PDU Set information in an RTP header extension, such as that in FIG. 2A or alternatively in FIG. 2B, the integrated 5GS handling of PDU Sets may benefit by being configured with additional information pertaining to the PDU Set marking configuration of an RTP sender. This will help for instance the PDU Set determination at the UPF, wherein the UPF does not require intensive deep packet header inspection processing, but rather selects the available in-band information available via RTP header extensions as configured to match the RTP sender behavior. However, there is currently no support for an ASP or alternatively signalling server NF, to exchange such PDU Set marking configuration with the 5GS. This disclosure provides solutions to signal this information to the 5GS over the NEF/PCF SBI via an XRM AF.

Aspects of the present disclosure are described in the context of a wireless communications system.

FIG. 8 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

5GS provides two services that can be used to request a particular QoS integrated handling behaviour to the PCF with PDU Set support for XR services. The first service is only available within the 5GS Trusted Domain via the Npcf_PolicyAuthorization APIs as per TS 29.514, over the PCF N5 interface, and the second one is available at the NEF via the Nnef_AFSessionWithQoS APIs as per TS 29.122. Both are meant to provide Application Service Providers (ASPs) to request an optimized QoS policy treatment for an application over the 5GS.

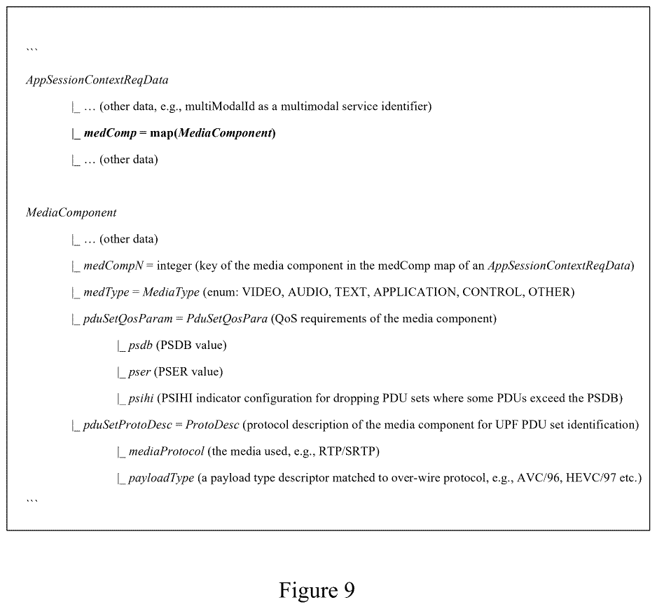

The Npcf_PolicyAuthorization APIs and data models allow for the creation of sessions with PDU Set for multiple media components over a single or multiple IP flows within the context of an application session, i.e., comprised within the AppSessionContextReqData object. The AppSessionContextReqData thus comprises an optional map of MediaComponents which can be populated by an AF (e.g., deployed within the Trusted Domain or via a NEF) to request for an application a particular PDU Set QoS policy for a media type, and protocol description as per TS 29.514, Clause 5.6.2.7, on type MediaComponent. This is illustrated in FIG. 9.

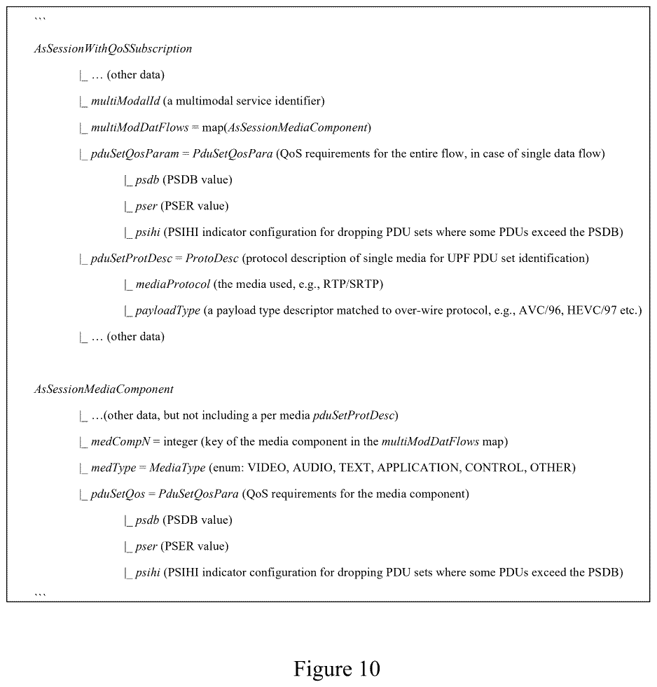

Similarly, the Nnef_AFSessionWithQOS APIs and data models allow for the creation of a session configured for an AS with PDU Set for multiple media components over a single or multiple IP flows within the context of an AsSessionWithQoSSubscription object and corresponding API. The AsSessionWithQoSSubscription thus comprises an optional map of type AsSessionMediaComponent like the MediaComponent in use of Npcf_PolicyAuthorization. As such, an AF can request on behalf of an AS a particular PDU Set QoS policy for a media type, and protocol description as per TS 29.122, Clause 5.14.2.1.2, based on type AsSessionMediaComponent. This is illustrated in FIG. 10.

The solution proposed here is based on a NF requesting from the 5GS, via a second NF (i.e., PCF, or alternatively, NEF), an application session with PDU Set QoS requirements. For the one trained in the art, the general solution herein is equivalently applicable to a UE requesting from the 5GS, via a NF based on Media Session Handling interfaces (i.e., as 5GS M5/RTC-5, and corresponding service-based APIs, e.g., the Maf_SessionHandling service API of an AF, a Media AF, or alike network functionality), an application session with PDU Set QoS requirements. The request configuration is set to include a PDU Set marking configuration corresponding to some embodiments wherein the RTP application sender (i.e., the AS, or alternatively, in other embodiments, the UE) marks the PDU Set information within an RTP header extension (e.g., as per urn:3gpp-pdu-set-marking-rel18 header extension syntax and semantics) as part of the RTP protocol used to transport the application data (e.g., video, audio, haptics, application metadata, or combinations thereof). The PDU Set marking configuration according to some embodiments includes at least the following information fields:
a version field identifying the syntax and semantics of the used RTP header extension for marking PDU Set information as registered with IANA (e.g., urn:3gpp-pdu-set-marking-rel18);
a format field as one of “short” or “long” according to RFC 8285 negotiated within the SDP offer/answer procedure;
an identifier field corresponding to the of the RTP header extension used to send the PDU set information (e.g. the identifier may correspond to the local identifier of the extmap SDP attribute defined in RFC 8285, as for instance local identifier “2” corresponding to the SDP line a=extmap:2 sendonly urn:3gpp:pdu-set-marking:rel-18 short pdu-set-size”) over the wire as part of one or more RTP header extensions negotiated within the SDP offer/answer procedure;
a PDU set size indicator field corresponding to an indication of activation of PDU Set Size information as part of the PDU Set information;
an origin IP version field corresponding to the IP version (e.g. IPv4, IPv6), used at the RTP sender to transmit the multimedia application data (necessary in some embodiments involving NATs before PSA UPF in N6 to help the UPF determine the correct PDU Set Size if reported); and
an end of data burst indicator field corresponding to an indication of activation of end of data bursts information as part of the PDU Set information.

In some embodiments, some of these fields are mandatory, e.g., at least one of the version, identifier, format fields, whereas in other embodiments some of these fields are optional, e.g., at least one of the version, format, origin IP version, PDU Set Size indicator, end of burst indicator.

### Specific Embodiments

In some embodiments, the PDU set marking configuration is comprised within a request to create an application session with QOS requirements corresponding to a Trusted Domain AF requesting an application session context, i.e., AppSessionContextReqData from the PCF over N5. Alternatively, the request may be placed in an update of an existing session, e.g., AppSessionContextUpdateData, AppSessionContextUpdateDataPatch.

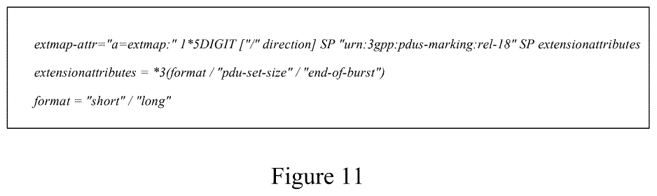

In one embodiment the requester may thus be implemented by a Trusted Domain, MNO-provided, WebRTC signaling server, or alternatively in IMS services a Proxy-Call Session Control Function (P-CSCF). In the latter embodiments, both the WebRTC signaling server, or alternatively the P-CSCF, would relay the SDP offer/answer procedure used between an RTP sender and an RTP receiver to negotiate the RTP session configuration including the RTP header extension configuration for marking PDU set information. For example, the RTP HE ABNF syntax within the SDP may be as illustrated in FIG. 11, whereby the extmap attribute and additional extension attributes determine the identifier (e.g., 5 used as local identifier as per RFC 8285 specification of RTP header extensions), the version (e.g., “urn:3gpp-pdus-marking:rel-18”), the format (“short” corresponding to one-byte extension format of RFC 8285/“long” corresponding to two-byte extension format of RFC 8285), and the presence of PDU Set Size optional information or the activation of end of data burst feature.

In some embodiments, the signaling server may further leverage the SDP negotiated connected IP flow information to determine the origin IP field information, whereas in other embodiments this information may be provided by external configuration through an ASP, or alternatively based on a fixed/managed network configuration.

In other embodiments, the PDU set marking configuration is comprised within a request to create an application session with QoS requirements corresponding to an AF outside the Trusted Domain, or alternatively, an ASP AF, requesting an application session with QoS subscription, i.e., AsSessionWithQoSSubscription from the NEF over N33. Alternatively, the request may be placed in an update of an existing session, e.g., AsSessionWithQoSSubscriptionPatch. In some embodiments the AF may be notified of what PDU set marking configuration to request on behalf of an application session by at least one of:
the AS by means of non-specified APIs implemented by an ASP (e.g., RTC-3 interface APIs),
by an ASP provisioning and configuration server,
by a Media Session Handler (MSH) over the media control plane procedures for dynamic policies available in the 5GS, e.g., via the RTC-5 interface and associated dynamic policies procedures.

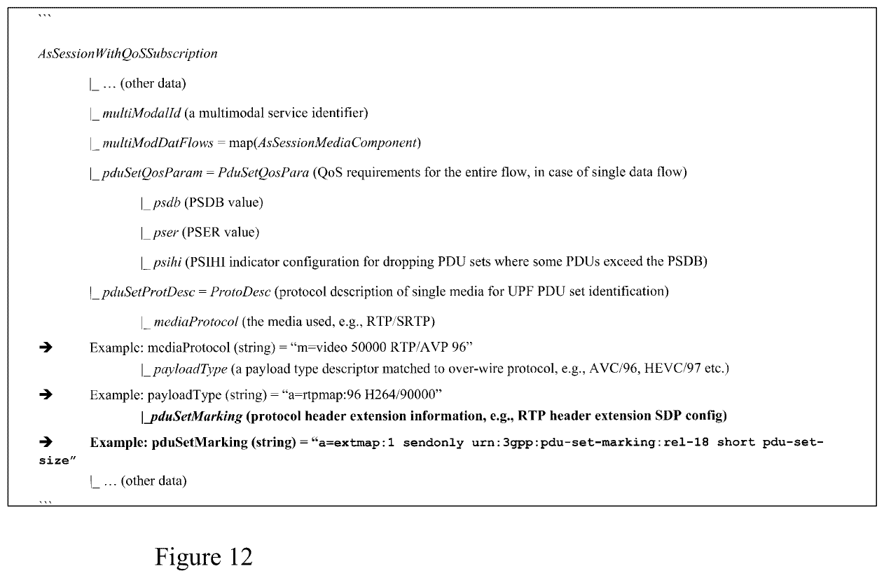

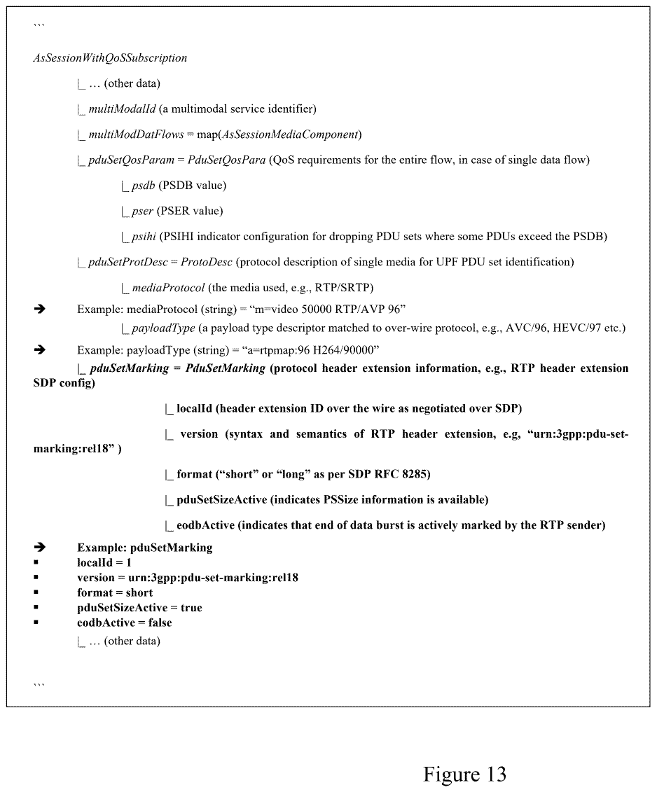

In some embodiments the PDU Set marking configuration may be embedded at a session level in the request data model representation, being common to one or more media streams (e.g., two or more RTP media streams, or mixed audio RTP sources). In an example applicable to an AsSessionWithQoSSubscription, this is represented as:
Example #1: Header extension information part of ProtoDesc data model and thus part of attribute pduSetProtDesc—see FIG. 12:
Example #2: Header extension information in parallel to ProtoDesc data model and with its own data model definition—see FIG. 13.
Further examples combining the two examples illustrated above are not precluded, as for instance including the header extension information as part of the ProtoDesc data model, yet with the header extension information having its own data model definition PduSetMatking.

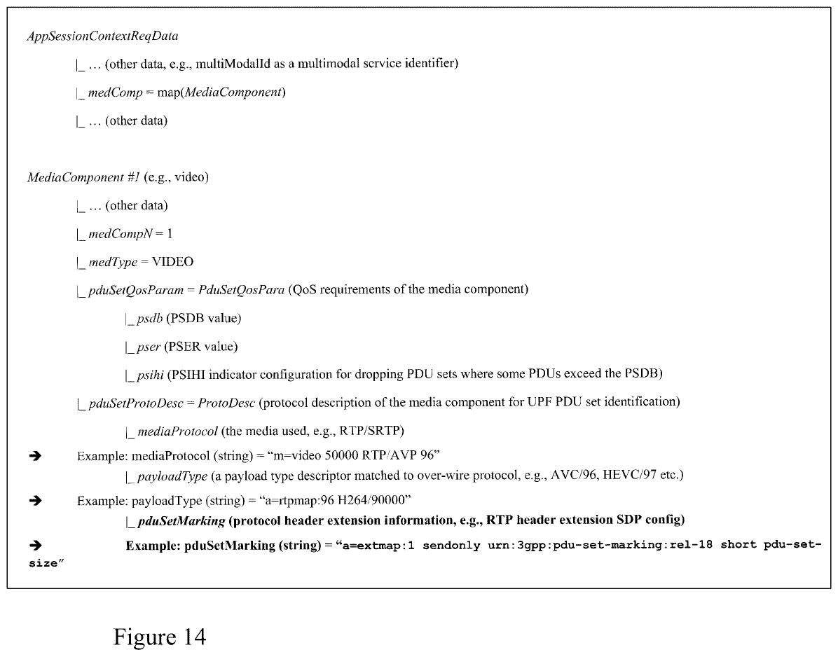

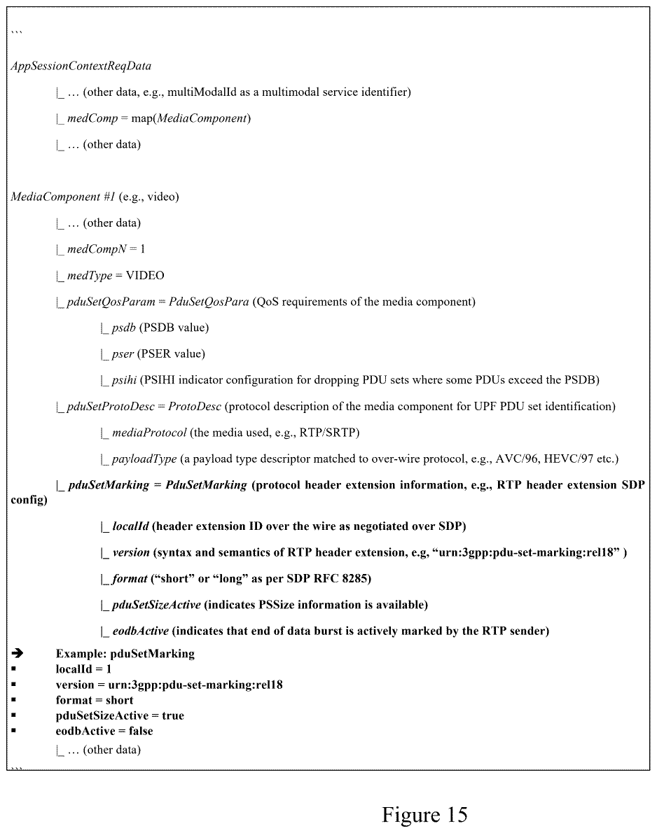

In other embodiments, the PDU marking configuration may be specific to a media component in the request data model representation, being specific to each corresponding one or more media streams (e.g., a PDU set marking configuration only for an RTP video stream, but not present for an RTP audio stream for an application session as per the RTP sender marking behavior). In an example applicable to an AppSessionContextReqData, this is represented as part of a MediaComponent as:
Example #1: Header extension info part of ProtoDesc data model and thus part of attribute pduSetProtDesc—see FIG. 14
Example #2: Header extension information in parallel to ProtoDesc data model and with its own data model definition—see FIG. 15
Further examples combining the two examples illustrated above are not precluded, as for instance including the header extension information as part of the ProtoDesc data model, yet with the header extension information having its own data model definition PduSetMatking.

One trained in the art should equally consider and equivalently apply the detailed procedures and examples above to update and patch (e.g., via HTTP PATCH) procedures available over N5 and N33 interfaces for a request of an application session with specific QOS treatment, i.e., AppSessionContextUpdateData/AppSessionContextUpdateDataPatch, or alternatively, AsSessionWithQoSSubscription/AsSessionWithQoSSubscriptionPatch.

Some embodiments additionally comprise within the request (e.g., AsSessionWithQoSSubscription over Npcf_PolicyAuthorization SBI, or alternatively, AppSessionContextReqData over Nnef_AFSessionWithQoS SBI) information about an origin IP version. The origin IP version corresponds to one of an IPV4 or IPv6 describing the IP version used by the source of the multimedia data session, e.g., an XRM AS, or alternatively, a multimedia AS.

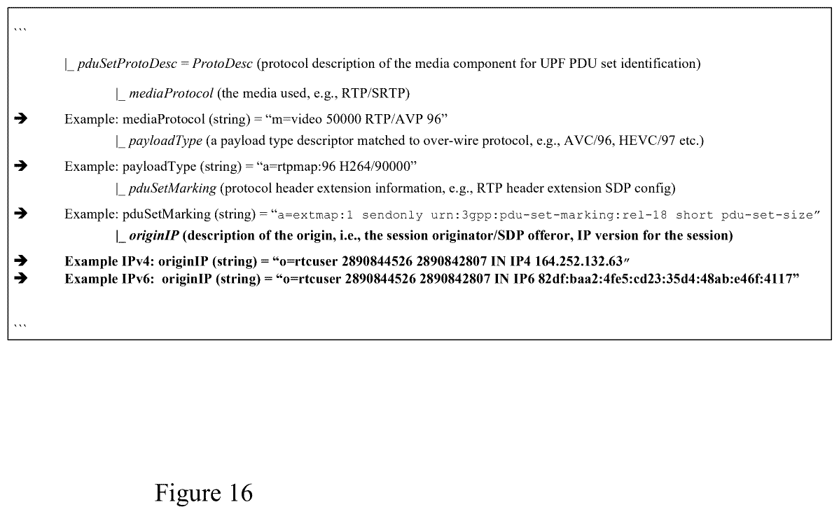

In some embodiments, the origin IP version may be comprised as an additional field within the ProtoDesc data model. An example embodiment may comprise the origin IP version as an originIP string-typed information element extending the protocol description ProtoDesc data model. The value of the originIP novel information element may be then assigned to a corresponding origin attribute of the RTP session established via an SDP offer-answer procedure between an RTP sender (e.g., an AS/UE as a first source) and an RTP receiver (e.g., a UE). For reference, one example is provided in FIG. 16.

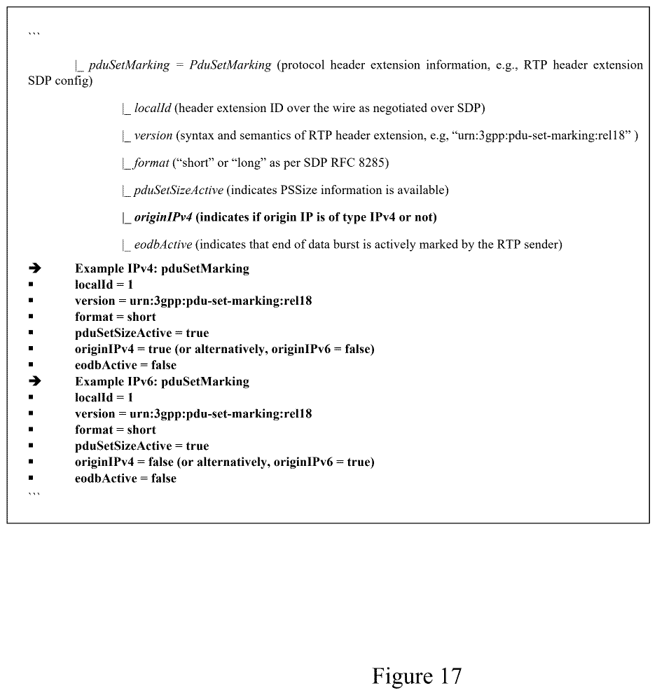

In other embodiments, the origin IP version may be comprised within the PduSetMarking data model as an additional information element. An example embodiment may comprise the origin IP version as an originIPv4, or alternatively originIPv6 Boolean-typed information element indicating one of the Boolean values encoding IPv4 and the other one encoding IPv6 (e.g., originIPv4 “true” for IPV4 and “false” for IPV6, or alternatively, originIPv6 “true” for IPV6 and “false” for IPV4). For reference, one example is provided in FIG. 17.

In one embodiment, the origin IP version information element of the session establishment request (e.g., AsSessionWithQoSSubscription over Npcf_PolicyAuthorization SBI, or alternatively, AppSessionContextReqData over Nnef_AFSessionWithQoS SBI) is common to all the media components of the multimedia session, and thus applies at a session level.

In some embodiments, the origin IP version information element is present in a configuration request (e.g., from the AF to the 5GS either to the PCF or to the NEF SBIs) conditionally based on the presence of PDU Set Size information, e.g., if pduSetSizeActive is “true”. This is determined by the requester, e.g., the AF, based on the AS corresponding signaling.

Providing PDU set marking configuration signaling to the 5GS via the PCF/NEF when an RTP sender (e.g., an AS/UE) is marking of PDU sets via RTP header extensions. The disclosure enables thus configuration and simplified processing in support of PDU Set determination at the UPF by providing:
the PDU Set marking configuration information as part of a MediaComponent/AsSessionMediaComponent in AF requests to PCF/NEF over AppSessionContextReqData/AsSessionWithQosSubscription for QoS support of PDU Set marked traffic; and
the PDU set marking configuration includes origin IP version signaling to support PDU Set Size indication including RTP/UDP/IP headers overhead.

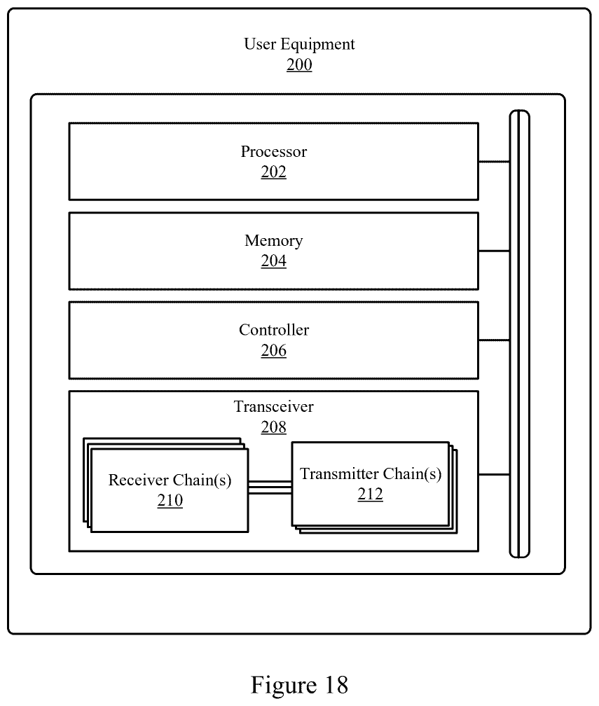

FIG. 18 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to support a means for causing the user equipment to transmit a user plane QoS session configuration request, the request comprising first and second information, wherein the first information indicates at least one of a type of media, a set of QoS parameters requirements, or a protocol description, for one or more media components of multimedia application data; and the second information indicates a PDU Set marking configuration identifying a PDU Set marking for the one or more media components, wherein the PDU Set marking configuration comprises information elements corresponding to or indicative of a Real Time Protocol, RTP, header extension configuration used for marking PDU Set information.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 2]08. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

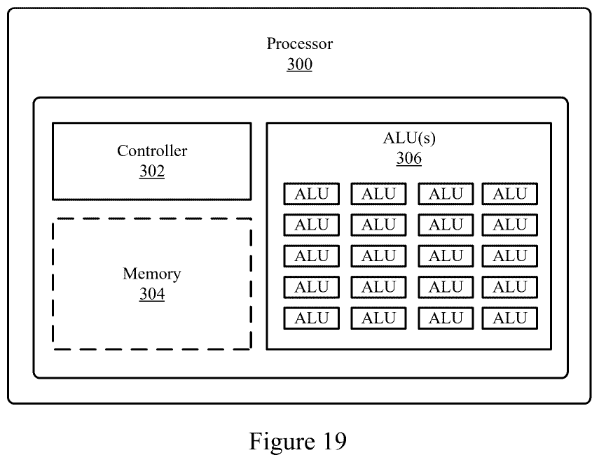

FIG. 19 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for sending a user plane QoS session configuration request, the request comprising first and second information, wherein, the first information indicates at least one type of media, a set of QoS parameters requirements, or a protocol description for one or more media components of multimedia application data, and the second information indicating a PDU Set marking configuration identifying a PDU Set marking for the one or more media components, wherein the PDU Set marking configuration comprises information elements corresponding to or indicative of a Real Time Protocol, RTP, header extension configuration used for marking PDU Set information.

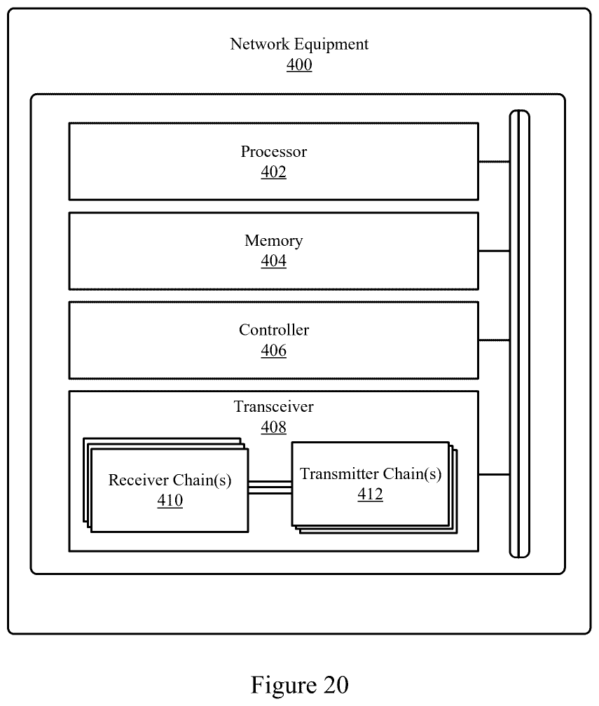

FIG. 20 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to support a means for sending a user plane QoS session configuration request, the request comprising first and second information, wherein the first information indicates at least one of a type of media, a set of QoS parameters requirements, or a protocol description for one or more media components of multimedia application data and the second information indicates a PDU Set marking configuration identifying a PDU Set marking for the one or more media components, wherein the PDU Set marking configuration comprises information elements corresponding to or indicative of a Real Time Protocol, RTP, header extension configuration used for marking the PDU Set information.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

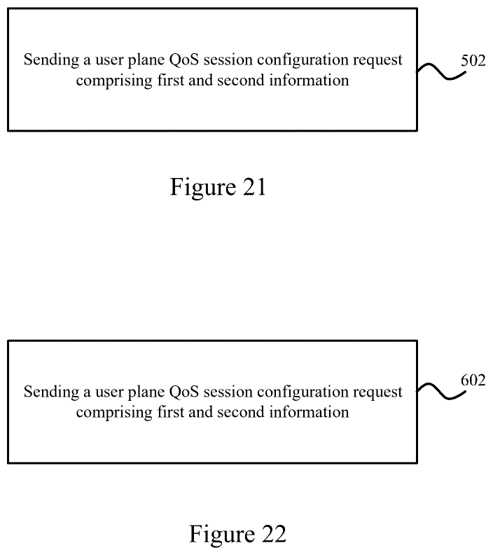

FIG. 21 illustrates a flowchart of a method in accordance with aspects of the present disclosure. The operations of the method may be implemented by a UE as described herein. In some implementations, the UE may execute a set of instructions to control the function elements of the UE to perform the described functions.

At 502, the method may include sending a user plane QoS session configuration request comprising first and second information as described above. In some implementations, aspects of the operations may be performed by a UE as described with reference to FIG. 18.

FIG. 22 illustrates a flowchart of a method in accordance with aspects of the present disclosure. The operations of the method may be implemented by a NE as described herein. In some implementations, the NE may execute a set of instructions to control the function elements of the NE to perform the described functions.

At 602, the method may include sending a user plane QoS session configuration request comprising first and second information as described above. The operations of 602 may be performed in accordance with examples as described herein. In some implementations, aspects of the operations of 602 may be performed by a NE as described with reference to FIG. 20.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment for wireless communication, comprising:
at least one memory; and
at least one processor coupled with the at least one memory and configured to cause the UE to:
transmit a user plane quality of service (QOS) session configuration request, the request comprising first and second information,
wherein the first information indicates at least one of a type of media, a set of QoS parameters requirements, or a protocol description, for one or more media components of multimedia application data; and
wherein the second information indicates a protocol data unit (PDU) Set marking configuration identifying a PDU Set marking for the one or more media components, wherein the PDU Set marking configuration comprises information elements corresponding to or indicative of a Real Time Protocol (RTP) header extension configuration used for marking PDU Set information.

2. The UE according to claim 1, wherein the at least one processor is further configured to cause the UE to operate as an RTP sender, and wherein the configuration request is sent within a service application programming interface (API) request to a service API belonging to a network function.

3. The UE of claim 1, wherein the second information is an information element within the first information.

4. The UE of any claim 1, wherein the RTP header extension configuration is based on a Software Defined Protocol (SDP) procedure, and wherein the information elements are encoded based on the SDP procedure.

5. The UE of claim 4, wherein the first information indicates a protocol description of at least one media component, and wherein the first information further comprises an information element indicating an Internet Protocol (IP) version associated with the multimedia application data, and wherein the IP version associated with the multimedia data is based at least in part on the SDP procedure.

6. The UE of claim 1, wherein the configuration request is:
common to one or more media components as part of a AsSession WithQoSSubscription or AsSession WithQoSSubscriptionPatch Service application programming interface (API) request; or
specific to each media component of the one or more media components as part of a AsSessionMediaComponent or MediaComponent service API request.

7. The UE of claim 2, wherein the network function is:
a Media Application Function or an XR Media Application Function;
a WebRTC Signaling Server; or
a Proxy Call Session Control Function (P-CSCF).

8. The UE of claim 4, wherein the information elements of the PDU Set marking configuration comprise:
a version field identifying syntax and semantics of the used RTP header extension for marking PDU Set information;
a format field identifying an RTP header extension format negotiated within the SDP procedure;
an identifier field corresponding to the RTP header extension used to send the PDU set information as part of one or more RTP header extensions negotiated within the SDP procedure;
a PDU set size indicator field corresponding to an indication of activation of PDU Set Size information as part of the PDU Set information;
an origin internet protocol (IP) version field corresponding to the IP version used at the RTP sender to transmit the multimedia application data; or
an end of data burst indicator field corresponding to an indication of activation of end of data bursts information as part of the PDU Set information.

9. The UE of claim 1, wherein the configuration request is included within a data model corresponding to:
a DynamicPolicy, ServiceDataFlowDescription, MediaComponent, or a MediaSubComponent included within a service application programming interface (API) request sent over an M5/RTC-5 interface to an application function (AF).

10. The UE of claim 1, wherein the type of media is one of video, audio, haptics, text, application and control, and the protocol description identifies a protocol type and an RTP payload type corresponding to the media encoding format contained in the RTP payload.

11. The UE of claim 1, wherein the set of QoS parameters requirements indicate at least a PDU Set Delay Budget and a PDU Set Error Rate.

12. (canceled)

13. A network entity for wireless communication, comprising:
at least one memory; and
at least one processor coupled with the at least one memory and configured to cause the network entity to:
send a user plane quality of service (QOS) session configuration request, the session configuration request comprising first and second information:
wherein the first information indicates at least one of a type of media, a set of QoS parameters requirements, or a protocol description for one or more media components of multimedia application data; and
the second information indicates a protocol data unit (PDU) Set marking configuration identifying a PDU Set marking for the one or more media components, wherein the PDU Set marking configuration comprises information elements corresponding to or indicative of a Real Time Protocol (RTP) header extension configuration used for marking the PDU Set information.

14. The network entity of claim 13, wherein the at least one processor is further configured to cause the network entity to; operate as a first network function and to cause the configuration request to be sent within a service application programming interface (API) request to a service API belonging to a second network function.

15. The network entity of claim 14, wherein the first
network function is: an Application Function (AF);
a WebRTC Signalling Server; or
a Proxy Call Session Control Function (P-CSCF).

16. The network entity of claim 14, wherein the second network function is:
a Policy Control Function, (PCF);
a Network Exposure Function (NEF).

17. The network entity of claim 13, wherein the PDU set marking is performed by an RTP sender, the RTP sender, and an RTP receiver using the RTP header extension configuration each being located at:
a user equipment (UE) including a Media Session Handler; and
an Application Server.

18. The network entity of claim 13, wherein the second information is an information element within the first information.

19. The network entity of claim 13, wherein the RTP header extension configuration is based on a Software Description Protocol (SDP) procedure, and wherein the information elements are encoded based on the SDP procedure.

20. The network entity of claim 13, wherein the configuration request is comprised within a data model corresponding to:
an AsSessionMediaComponent included within one of:
an AsSession WithQosSubscription, and
an AsSession WithQosSubscriptionPatch request over an N33 interface to a network exposure function (NEF); and
a MediaComponent included within one of: an
AppSessionContextReqData,
an AppSessionContextUpdateData, or
an AppSessionContextUpdateDataPatch request over an N5 interface to a policy control function (PCF).

21. A method performed by a user equipment (UE), the method comprising:
transmitting a user plane quality of service (QOS) session configuration request, the request comprising first and second information,
wherein the first information indicates at least one of a type of media, a set of QoS parameters requirements, or a protocol description, for one or more media components of multimedia application data; and
wherein the second information indicates a protocol data unit (PDU) Set marking configuration identifying a PDU Set marking for the one or more media components, wherein the PDU Set marking configuration comprises information elements corresponding to or indicative of a Real Time Protocol (RTP) header extension configuration used for marking PDU Set information.
